(19) United States
(12) Patent Application Publication
(10) Pub. No.: US 2008/0090448 A1
(43) Pub. Date: Apr. 17, 2008

(54) DISPLAY DEVICE AND METHOD OF MANUFACTURING THE SAME

(75) Inventor: TAE-KYOUNG KANG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/850,817

(22) Filed: Sep. 6, 2007

(30) Foreign Application Priority Data
Oct. 17, 2006 (KR) 2006-101037

(51) Int. Cl. H01R 3/00; H01R 43/20

(52) U.S. Cl. 439/488; 29/825

(57) ABSTRACT

A display device includes a panel comprising at least one group of electrode terminals; at least one signal transfer unit having first signal transfer unit terminals that connect with electrode terminals of the at least one group of electrodes; and alignment mark units formed on the electrode terminals and the terminals of the signal transfer units respectively in order to align positions of the terminals of the signal transfer units with respect to the electrode terminals, wherein the alignment mark units overlap each other in a region in which the electrode terminals and the terminals of the signal transfer units are arranged. The signal transfer units can be electrically connected to electrode terminals at desired positions by forming alignment mark units, which allows the desired position to be found when the electrode terminals overlap the signal transfer units, in a region in which the grouped electrode terminals and the signal transfer units are arranged.

### CROSS-REFERENCE TO RELATED APPLICATION

This application claims the benefit of Korean Application No. 2006-101037, filed Oct. 17, 2006, in the Korean Intellectual Property Office, the disclosure of which is incorporated herein by reference.

### BACKGROUND OF THE INVENTION

1. Field of the Invention

Aspects of the present invention relates to a display device, and more particularly, to a display device having an improved structure and manufacturing process to facilitate position alignment when connecting a panel and signal transfer units, and a method of manufacturing the same.

2. Description of the Related Art

Generally, flat panel display devices are classified into emissive type flat panel display devices and non-emissive type flat panel display devices. Emissive flat panel display devices include flat panel cathode ray tubes (flat panel CRTs), plasma display panels (PDPs), field emission displays (FEDs), light emitting diodes (LEDs), and so on. Non-emissive flat panel display devices include liquid crystal displays (LCDs).

PDPs are display devices that display a desired image including text or graphics by ionizing a discharge gas sealed between substrates on which a plurality of discharge electrodes are disposed, and exciting phosphor layers with ultraviolet (UV) rays generated by the ionized discharge gas. The discharge electrodes are grouped and electrically connected to terminals of signal transfer units such as flexible printed cables.

FIG. 1 is a plan view of a conventional signal transfer unit. Referring to FIG. 1, conventional signal transfer units 101 are formed one after another on a reel-to-reel type film and divided into individual elements by a punching process. Terminals of the signal transfer units 101 are then connected to electrode terminals of a plasma display panel and connectors of a driving circuit board, respectively.

Structurally, each conventional signal transfer unit 101 includes a plurality of first terminals 102 disposed in a line at one end of the signal transfer unit 101 for connection with the electrode terminals of the panel and a plurality of second terminals 103 disposed in a line at the other end of the signal transfer unit 101 for connection with the connectors of the driving circuit board. Alignment mark units 104 are formed at both ends of the group of the first terminals 102 in order to align the first terminals 102 with respect to the electrode terminals of the panel.

As larger panels are developed, requiring an increased number of the first terminals 102 in each signal transfer unit 101, the space available on the conventional signal transfer unit 101 for the alignment mark units 104 is reduced.

For example, referring to FIG. 1, a maximum effective length L1 to prevent interference between the adjacent signal transfer units 101 may be 59 mm, and lengths L3 and L4 of regions for the alignment mark units 104 to be formed may together be 4 mm.

In a panel design in which the signal transfer unit has 384 channels (requiring 384 first terminals 102), the pitch between the electrode terminals of the panel should be at least 150 μm to prevent a vertical line defect on the display region.

However, when the length L2 of a region on which 384 first terminals 102 are disposed is 55 mm, the pitch between the electrode terminals is 143 μm, not 150 μm. In this case, since the electrode terminals must be placed too closely together, vertical line defects are not prevented.

### SUMMARY OF THE INVENTION

Aspects of the present invention provide a display device having an improved structure to provide alignment mark units on electrode terminals and signal transfer units respectively so as to facilitate position alignment between the electrode terminals of a panel and terminals of the signal transfer units, and a method of manufacturing the same.

According to an aspect of the present invention, there is provided a display device including a panel comprising a panel comprising a plurality of groups of electrode terminals; a plurality of signal transfer units, each signal transfer unit comprising a plurality of first terminals that connect with one of the groups of electrode terminals of the panel; and a plurality of alignment mark units formed on the electrode terminals and the terminals of the signal transfer units respectively in order to align positions of the terminals of the signal transfer units with respect to the electrode terminals, wherein the alignment mark units overlap each other in a region in which the electrode terminals and the terminals of the signal transfer units are arranged.

According to an aspect of the present invention, the alignment mark units may include a plurality of first alignment mark units formed on the electrode terminals; and a plurality of second alignment mark units formed on the first terminals of the signal transfer units.

According to an aspect of the present invention, each first alignment mark unit may be integrally formed with an electrode terminal.

According to an aspect of the present invention, each second alignment mark unit may include a recognition unit in which an opening is formed to determine a position of a corresponding first alignment mark unit when the second alignment mark units overlap on the first alignment mark units.

According to an aspect of the present invention, each electrode terminal having an integrally formed first alignment mark includes a pair of sidewalls and wherein each first alignment mark unit may be integrally formed with the electrode terminals by extending a predetermined region from the electrode terminals.

According to an aspect of the present invention, with respect to each signal transfer unit, the first terminals may be aligned in a row extending across a width of the signal transfer unit and each signal transfer unit may include at least two second alignment mark units adjacent to the row of first terminals.

According to an aspect of the present invention, instead of being formed on the electrode terminals, the first alignment mark units may be separately disposed in front of the electrode terminals.

According to an aspect of the present invention, the second alignment mark units may be formed of a white conductive material to prevent reflection of light.

According to another aspect of the present invention, there is provided an electrode terminal-signal transfer unit assembly comprising a group of spaced apart electrode terminals; a signal transfer unit having a plurality of signal transfer unit terminals; first alignment mark units formed on at least two of the electrode terminals; and second alignment mark units formed on the signal transfer unit, wherein the group of spaced apart electrode terminals and the signal transfer unit are moveable with respect to each other from a separated or misaligned position to an aligned position, wherein the signal transfer unit terminals are spaced apart such that each electrode terminal aligns with and contacts one of the signal transfer unit terminals when the group of spaced apart electrode terminals and the signal transfer unit are in the aligned position; and wherein the second alignment mark units overlap the first alignment mark units when the group of spaced apart electrode terminals and the signal transfer unit are in the aligned position.

According to another aspect of the present invention, there is provided a method of manufacturing a display device including preparing a substrate on which a plurality of grouped electrode terminals are patterned; aligning a plurality of terminals of a plurality of signal transfer units on the substrate in order to electrically connect the terminals to the substrate; disposing a plurality of second alignment mark units, which are formed on the signal transfer units, on a plurality of first alignment mark units, which are formed on electrode terminals, thereby determining positions of the first alignment mark units in a region in which the electrode terminals and the terminals of the signal transfer units are arranged; and electrically connecting the electrode terminals and the terminals by thermal bonding.

According to another aspect of the present invention, there is provided a method of joining a group of electrode terminals to a signal transfer unit having a plurality of signal transfer unit terminals, wherein each of the electrode terminals aligns with and contacts one of the signal transfer unit terminals in an aligned position, the method comprising providing first alignment marks on at least two of the electrode terminals; and second alignment marks on the signal transfer unit wherein the second alignment mark units overlap the first alignment mark units when the group of spaced apart electrode terminals and the signal transfer unit are in the aligned position; positioning the group of spaced apart electrode terminals and the signal transfer unit so that the second alignment mark units overlap the first alignment mark units, thereby placing the group of electrode terminals and the signal transfer unit in the aligned position; and electrically connecting the group of electrode terminals and plurality of signal transfer unit terminals by thermal bonding.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view of a conventional signal transfer unit;

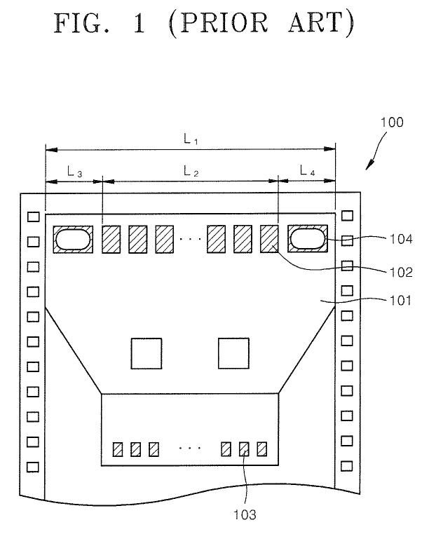

FIG. 2 is an exploded perspective view of a portion of a panel according to an embodiment of the present invention;

FIG. 3 is an exploded perspective view of a display device including the panel of FIG. 2, according to an embodiment of the present invention;

FIG. 4 is a sectional view of the display device of FIG. 3, according to an embodiment of the present invention;

FIG. 5 is a plan view of a panel, signal transfer units, and a driving circuit board arranged, according to an embodiment of the present invention;

FIG. 6 is a plan view of alignment mark units of FIG. 5, according to an embodiment of the present invention;

FIG. 7 is a plan view of the alignment mark units of FIG. 6 when first and second alignment mark units are combined, according to an embodiment of the present invention;

FIG. 8 is a plan view of alignment mark units according to another embodiment of the present invention; and

FIG. 9 is a plan view of alignment mark units according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, aspects of the present invention will be described in detail by explaining embodiments of the invention with reference to the attached drawings.

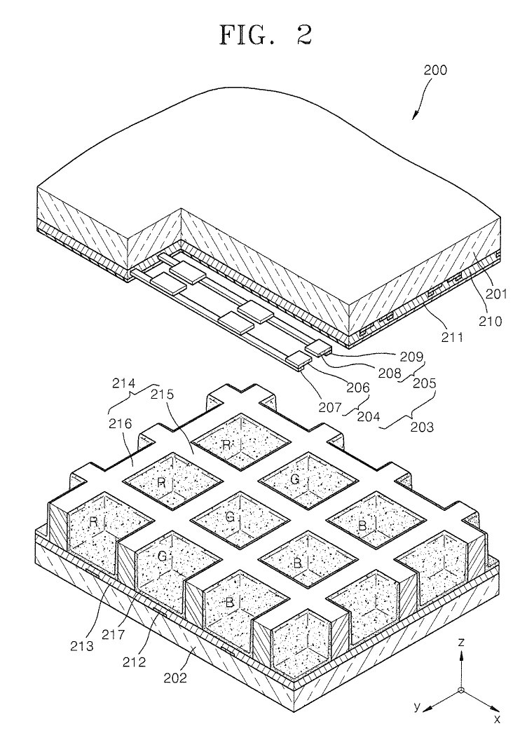

FIG. 2 is an exploded perspective view of a portion of a three-electrode surface discharge type panel 200 according to an embodiment of the present invention. Referring to FIG. 2, the panel 200 includes a first substrate 201 and a second substrate 202 disposed parallel to the first substrate 201. Frit glass (not shown) is coated on edges of facing surfaces of the first and second substrates 201 and 202.

The first substrate 201 may be a transparent substrate such as a soda lime glass, a semi-transmissible substrate, a reflexible substrate, a colored substrate, or the like.

Pairs of sustain discharge electrodes 203 are disposed on an inner surface of the first substrate 201. Each pair of sustain discharge electrodes 203 includes an X electrode 204 and a Y electrode 205, and a pair of sustain discharge electrodes 203 is disposed in each of a plurality of discharge cells.

Each of the X electrodes 204 includes first transparent electrodes 206 disposed separately in each of the discharge cells and a first bus electrode line 207, which extends in an X direction of the panel 200 along the adjacent discharge cells and electrically connects the first transparent electrodes 206.

Each of the Y electrodes 205 includes second transparent electrodes 208 disposed separately in each of the discharge cells and a second bus electrode line 209, which extends in the X direction of the panel 200 along the adjacent discharge cells and electrically connects the second transparent electrodes 208.

The horizontal cross-section of the first and second transparent electrodes 206 and 208 is rectangular and a predetermined discharge gap is formed between the first and second transparent electrodes 206 and 208 in the center of each of the discharge cells. The first and second electrode lines 207 and 209 are stripe-shaped and are disposed on both edges of facing sides of the discharge cells.

The first and second transparent electrodes 206 and 208 are formed of a transparent conductive film such as indium tin oxide (ITO) film, and the first and second bus electrode lines 207 and 209 are formed of an Ag paste having a high conductivity or a metal such as Cr—Cu—Cr.

The X and Y electrodes 204 and 205 are buried by a first dielectric layer 210 formed of a transparent dielectric, such as, for example, a high-dielectric material such as PbO—B₂O₃—SiO₂.

A protective layer formed of MgO is disposed on a surface of the first dielectric layer 210 to increase an amount of secondary emission. The protective layer 211 is evaporated onto the surface of the first dielectric layer 210.

The second substrate 202 may be a transparent substrate, a semi-transmissible substrate, a reflexible substrate, a colored substrate, or the like. Address electrodes 212 are disposed to cross the Y electrodes 205 on an inner surface of the second substrate 202.

The address electrodes 212 are stripe-shaped and extend in a Y direction of the panel 200 to cross the adjacent discharge cells. The address electrodes 212 are buried by a second dielectric layer 213. The second dielectric layer 213 is formed of a high-dielectric material similar to the first dielectric layer 210.

Barrier ribs 214 are disposed between the first and the second substrates 201 and 202. The barrier ribs 214 are formed to define the discharge cells and prevent crosstalk between adjacent discharge cells.

The barrier ribs 214 include first barrier ribs 215 extending in the X direction of the panel 200 and second barrier ribs 216 extending in the Y direction of the panel 200. The first barrier ribs 215 extend in a direction from inner walls of the second barrier ribs 216 and separate discharge space into a matrix.

The barrier ribs 214 are not limited to the above structure, and any other structure is possible as long as the structure can define discharge cells. Also, the horizontal cross-section of the discharge cells may be polygonal, circular, oval as well as rectangular.

The discharge space defined by the first and second substrates 201 and 202 and the barrier ribs 214 is filled with a discharge gas such as Ne—Xe or He—Xe.

Phosphor layers 217, which are excited by ultraviolet (UV) rays generated from the discharge gas and emit visible light to realize colored images, are formed in the discharge cells. The phosphor layers 217 are formed on the second dielectric layer 213 and the inner walls of the barrier ribs 214 in the present embodiment. However, the phosphor layers 217 may be formed in any region of the discharge cells.

As a non-limiting example, the phosphor layers 217 may formed of red, green, and blue phosphor layers. As specific non-limiting examples, the red phosphor layers may be formed of (Y,Gd)BO₃;Eu⁺³, the green phosphor layers may be formed of Zn₂SiO₄:Mn²⁺ and the blue phosphor layers may be formed of BaMgAl₁₀O₁₇:Eu²⁺.

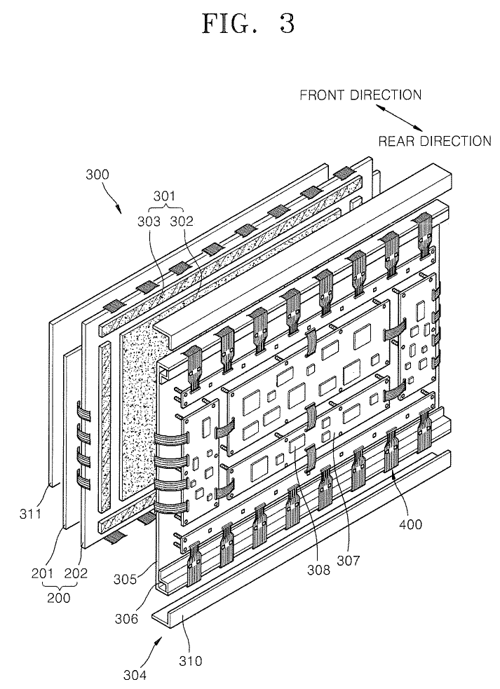

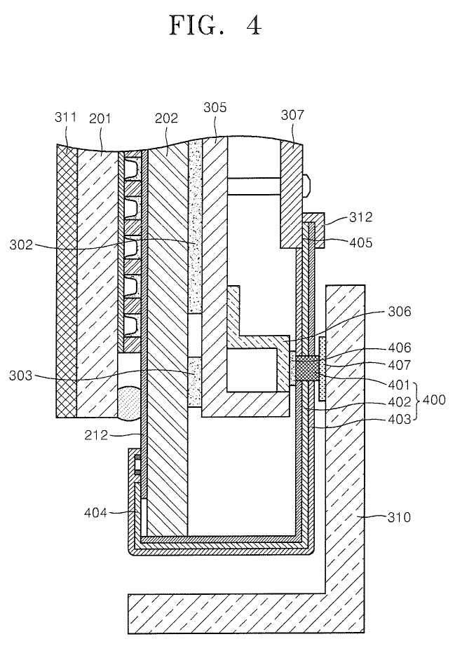

FIG. 3 is an exploded perspective view of a display device 300, including the panel 200 of FIG. 2, and FIG. 4 is a sectional view of the combined display device 300 of FIG. 3, according to an embodiment of the present invention.

Referring to FIGS. 3 and 4, the display device 300 includes the panel 200 including the first substrate 201 and the second substrate 202.

A chassis base assembly 304 is attached to the back of the panel 200. Specifically, a chassis base 305 is attached to a rear surface of the second substrate 202 by an adhesive material 301. The adhesive material 301 is adhered to the center of the rear surface of the second substrate 202 and includes a thermal conductive sheet 302, which transfers heat generated by an operation of the panel 200 to the chassis base 305, and double-sided adhesive tape 303, which is attached to edges of the rear surface of the second substrate 202.

Chassis reinforcing members 306 are disposed at the top and bottom of a rear surface of the chassis base 305, and cover plates 310 are disposed at the back of the chassis base 305 to cover the top and bottom portions of the chassis base 305.

A plurality of driving circuit boards 307 are mounted on the rear surface of the chassis base 305, and a plurality of circuit elements 308 are mounted on the driving circuit boards 307. Each of the plurality of signal transfer units 400 are electrically connected at one end to one of the circuit elements 308, respectively, and at the other end to a plurality of grouped electrode terminals of the panel 200 to transfer electrical signals between the panel 200 and the driving circuit boards 307.

The signal transfer units 400 include a plurality of driver integrated circuits (ICs) 401, leads 402 connected electrically with the driver ICs 401, and flexible films 403, which bury the leads 402. First terminals 404 are formed at one end of the leads 402 and are connected with the electrode terminals formed on the panel 200, and second terminals 405 are formed at the other end of the leads 402 and are connected with connectors 312 of the driving circuit boards 307. The films 403 bury the leads 402 except for at the first and second terminals 404 and 405.

The signal transfer units 400 are disposed between the chassis reinforcing members 306 and the cover plates 310. Thermal grease 406 is disposed between the driver ICs 401 and the chassis reinforcing members 306, and silicone sheets 407 are disposed between the driver ICs 401 and the cover plates 310.

Meanwhile, a filter 311 is adhered directly to a front surface of the panel 200. The filter 311 blocks electromagnetic waves generated by the panel 200, neon glow, and reflection of external light.

To achieve this, the filter 311 is formed of a plurality of films stacked on top of one another. For example, an antireflection film prevents the deterioration of visibility caused by reflection of external light, an electromagnetic wave shielding filter blocks electromagnetic waves generated by an operation of the panel 200 itself, and a wavelength selective absorbing film absorbs neon glow and screen glow in a region of 590 nm. Additional films with a variety of functions can be included in the filter 311.

A plurality of alignment mark units are formed both on the electrode terminals and the signal transfer units 400 formed on the panel 200. The alignment mark units are described in detail as follows.

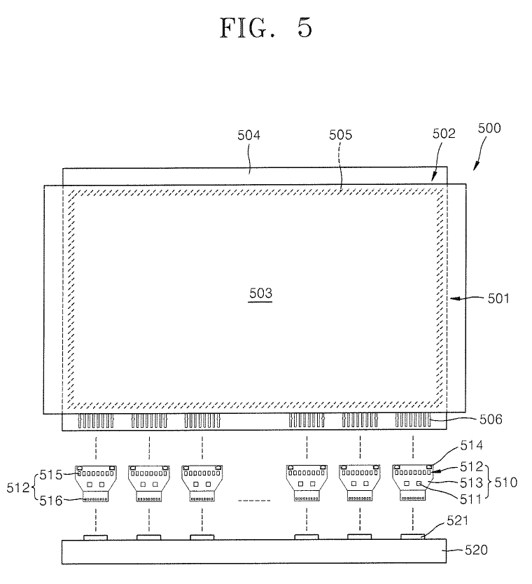

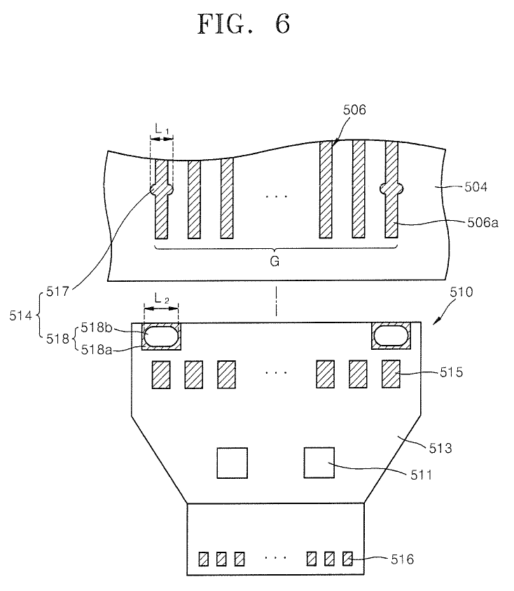

FIG. 5 is a plan view of a panel 500, signal transfer units 510, and a driving circuit board 520, arranged according to an embodiment of the present invention. FIG. 6 is a plan view of alignment mark units 514 of FIG. 5, according to an embodiment of the present invention.

Referring to FIGS. 5 and 6, the panel 500 can be divided into a display area 503 where first and second substrates 501 and 502 overlap each other and a non-display area 504 disposed outside of a border of the display area 503. Frit glass 505 is coated in a boundary region between the display area 503 and the non-display area 504 in order to seal the display area 503 from the outside.

The display area 503 is a region for displaying images, and includes regions where functional layers such as electrodes, dielectric layers, barrier ribs, and phosphor layers are formed into various patterns. The non-display area 504 is a region for electrically connecting the display area 503 to the signal transfer units 510, and includes regions where electrode terminals 506, which extend from discharge electrodes disposed in the display area 503, are disposed.

In larger plasma display panels such as the panel 500 shown in FIG. 500, the electrode terminals 506 are grouped and each group G of electrode terminals is connected to a respective signal transfer unit 510.

The signal transfer units 510 connect the electrode terminals 506 and connectors 512 of the driving circuit board 520, transfer electrical signals therebetween, and can be formed in various structures of shapes. In the present embodiment, the signal transfer units 510 include a plurality of driver ICs 511, leads 512 connected electrically with the driver ICs 511, flexible films 513, which bury the leads 512 except for first terminals 515 formed at one end of the leads 512, and second terminals 516 formed at the other end of the leads 512. The first terminals 515 are connected electrically to the electrode terminals 506, and the second terminals 516 are connected electrically to the connectors 521.

Alignment mark units 514 are formed on the electrode terminals 506 and the signal transfer units 510, respectively. The alignment mark units 514 include first alignment mark units 517 formed on the electrode terminals 506 and second alignment mark units 518 formed on the signal transfer units 510. The second alignment mark units 518 overlap with the first alignment mark units 517 and combine with the first alignment mark units 517 such that the exact position of the first terminals 515 of the signal transfer units 510 can be determined with respect to the electrode terminals 506.

The first alignment mark units 517 are integrally formed with the electrode terminals 506. Specifically, the first alignment mark units 517 are formed by extending a predetermined region in both outermost electrode terminals 506a of the group G of electrode terminals 506. The first alignment mark units 517 are formed in an oval shape, but the shape is not limited thereto. Any shape is possible as long as the shape is a structure that extends from the electrode terminals 506.

The second alignment mark units 518 include recognition units 518a in which opening holes 518b are formed to determine a position of the first alignment mark units 517 when the second alignment mark units 518 are disposed on the first alignment mark units 517.

The recognition units 518a may be formed to be rectangular, but the shape is not limited thereto. The opening holes 518b are formed in the same shape as the first alignment mark units 517, such as, for example, in an oval shape, in the center of the recognition units 518a. Here, the width L2 of the opening holes 518b may be greater than the width L1 of the first alignment mark units 517 such that the position of the first alignment mark units 517 can be determined using the opening holes 518b when the second alignment mark units 518 overlap on the first alignment mark units 517.

The second alignment mark units 518 are disposed in front of the first terminals 515. More specifically, the second alignment mark units 518 are disposed, with respect to the first terminals 515, at an end of the film 513 opposite to the end of the film 513 in which the driver ICs 511 are disposed.

The first alignment mark units 517 are integrally formed with the outermost electrode terminals 506a of the group G of the electrode terminals 506 by extending a predetermined region in both outermost electrode terminals 506a of the group G of the electrode terminals 506. The second alignment mark units 518 are formed in front of the first terminals 515 disposed at the outermost ends of the signal transfer units 510 corresponding to positions of the first alignment mark units 517. Although, according to the current embodiment, the first alignment mark units 517 are integrally formed with both of the outermost electrode terminals 506a, the present invention is not limited thereto. Alternatively, the first alignment mark units 517 may be integrally formed with any two of the electrode terminals 506 as long as the first alignment mark units 517 are formed in the group G of the electrode terminals 506 and the second alignment mark units 518 are formed on the first terminals 515 to correspond to the first alignment mark units 517.

The first and second alignment mark units 517 and 518 are formed of a white conductive material to prevent reflection of light. For example, the first and second alignment mark units 517 and 518 may be formed of Ag, Pt, Au, or alloys thereof.

For convenience, the first alignment mark units 517 are formed of substantially the same material as that used to form the electrode terminals 506 and the second alignment mark units 518 are formed of the same material as that used to form the leads 512 of the signal transfer units 510.

The recognition units 518a of the second alignment mark units 518 are patterned on the films 513 in a rectangular shape and the opening holes 518b, in which a conductive paste is not formed, are formed in the center of the recognition units 518a. Alternatively, the second alignment mark units 518 can be formed by forming only the opening holes 518b by, for example, perforating the films 513.

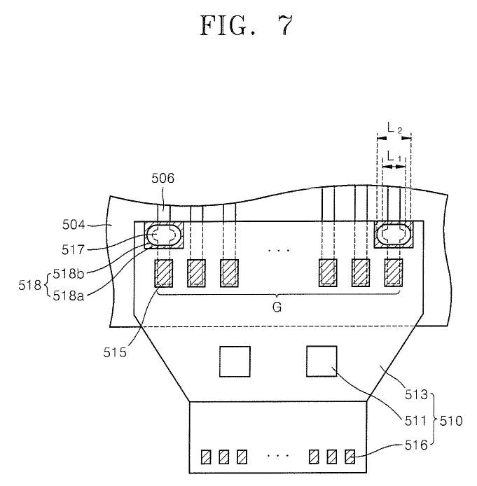

FIG. 7 is a plan view of the alignment mark units 514 of FIG. 6 when signal transfer unit 510 is connected to the non-display area 504 such that the first and second alignment mark units 517 and 518 are aligned, according to an embodiment of the present invention.

A procedure to connect the signal transfer units 510 to the non-display area 504 of the panel 500 according to an aspect of the present invention is described as follows.

First, the signal transfer units 510 are arranged on the non-display area 504 of the panel 500. Here, electrode terminals 506 patterned on the non-display area 504 of the panel 500 are arranged to correspond to the first terminals 515 of the signal transfer units 510.

Then, second alignment mark units 518 are positioned to overlap the first alignment mark units 517 in order to connect the first terminals 515 at desired positions with respect to the electrode terminals 506.

That is, the position of the first alignment mark units 517 is determined using the opening holes 518b formed in the center of the recognition units 518a when the second alignment mark units 518 overlap on the first alignment mark units 517.

The width L2 of the opening holes 518b is relatively greater than the width L1 of the first alignment mark units 517. Accordingly, the position of the first alignment mark units 517 can be determined using the opening holes 518b with the help of a vision device.

After the correct position of the first terminals 515 with respect to the electrode terminals 506 is determined using the above procedure, an anisotropic conductive film (ACF, not shown) is disposed between the electrode terminals 506 and the first terminals 515, and the electrode terminals 506 and the first terminals 515 are connected electrically using a thermal bonding method.

As such, differently from conventional technology in which alignment mark units are formed on outermost regions of a group of electrode terminals and outermost terminals of a signal transfer unit to correspond to each other, according to the present invention, the first alignment mark units 517 formed in order to align the first terminals 515 with respect to the electrode terminals 506 overlap the second alignment mark units 518 on both of the outermost electrode terminals 506a of the group G and the first terminals 515 to correspond to the outermost electrode terminals 506a.

Although, according to the current embodiment, the first and second alignment mark units 517 and 518 overlap each other on both of the outermost electrode terminals 506a of the group G and the first terminals 515 to correspond to the outermost electrode terminals 506a, the present invention is not limited thereto. The first and second alignment mark units 517 and 518 may overlap each other on any two of the electrode terminals 506 as long as the first alignment mark units 517 are formed in the group G of the electrode terminals 506 and the second alignment mark units 518 are formed on the first terminals 515 to correspond to the first alignment mark units 517.

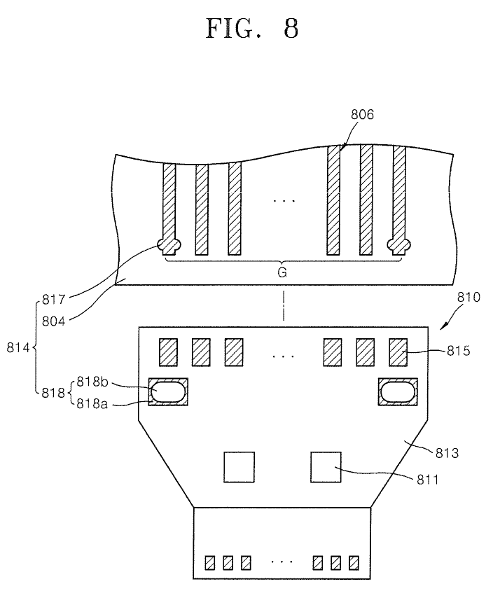

FIG. 8 is a plan view of a non-display area 804 of a panel and alignment mark units 814 of a signal transfer unit 810 according to another embodiment of the present invention. Referring to FIG. 8, a group G of electrode terminals 806 are arranged in a line on the non-display area 804 of the panel. First terminals 815 of the signal transfer unit 810 can be connected electrically to the electrode terminals 806.

First alignment mark units 817 are integrally formed with both of the outermost electrode terminals by extending a predetermined region in both of the outermost electrode terminals. The first alignment mark units 817 protrude from both sidewalls of the two outermost electrode terminals and are integrally formed in an oval shape with the two outermost electrode terminals.

Second alignment mark units 818 are formed on the signal transfer unit 810. The second alignment mark units 818 are formed at the rear of the first terminals 815. That is, the second alignment mark units 818 are formed between the first terminals 815 and the driver ICs 811.

Accordingly, the position of the first alignment mark units 817 can be determined using opening holes 818b of the second alignment mark units 818 when the second alignment mark units 818 overlap the first alignment mark units 817 such that a thermal bonding of the electrode terminals 806 and the first terminals 815 is possible at desired positions.

As such, the first and second alignment mark units 817 and 818 overlap each other when the group G of the electrode terminals 806 and the first terminals 815 are correctly positioned.

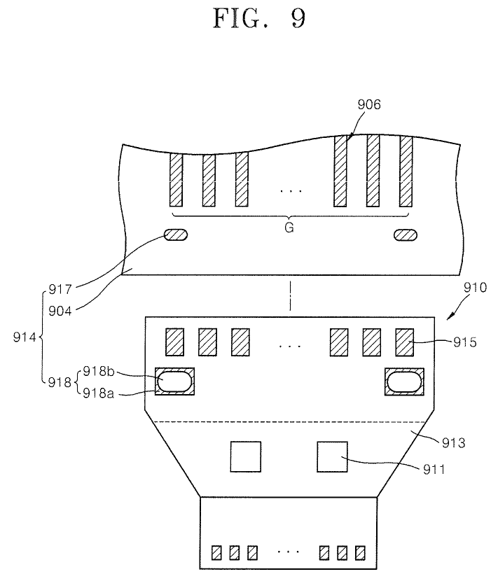

FIG. 9 is a plan view of a non-display area 904 of a panel and alignment mark units 914 of a signal transfer unit 910 according to another embodiment of the present invention. Referring to FIG. 9, a group G of electrode terminals 906 are arranged in a line on the substrate 904. First terminals 915 of the signal transfer unit 910 can be connected electrically to the electrode terminals 906.

First alignment mark units 917 are formed in front of both of the outermost electrode terminals. That is, the first alignment mark units 917 are formed between the two outermost electrode terminals and an end of the non-display area 904 of the panel.

The first alignment mark units 917 and the electrode terminals 906 are separated with a predetermined space therebetween and are not electrically connected to each other. Second alignment mark units 918 are disposed between the first terminals 915 and the driver ICs 911.

Accordingly, the position of the first alignment mark units 917 can be determined using opening holes 918b formed in the center of recognition units 918a of the second alignment mark units 918 when the second alignment mark units 918 overlap the first alignment mark units 917. A thermal bonding of the electrode terminals 906 and the first terminals 915 is possible.

As such, the first and second alignment mark units 917 and 918 overlap each other when the group G of the electrode terminals 906 and the first terminals 915 are correctly positioned.

As described above, signal transfer units can be electrically connected to electrode terminals at desired positions by forming alignment mark units, which allows for the exact positions to be found when the electrode terminals overlap the signal transfer units.

Furthermore, as the size of display devices increases, by forming alignment mark units, the pitch of electrode terminals can be minimized and panel defects can be prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A display device comprising:
a panel comprising a plurality of groups of electrode terminals;
a plurality of signal transfer units, each signal transfer unit comprising a plurality of first terminals that connect with one of the groups of electrode terminals of the panel; and
a plurality of alignment mark units formed on the electrode terminals and the terminals of the signal transfer units respectively, in order to align positions of the terminals of the signal transfer units with respect to the electrode terminal,
wherein the alignment mark units overlap each other in a region in which the electrode terminals and the terminals of the signal transfer unit are arranged.

2. The display device of claim 1, wherein the alignment mark units comprise:
a plurality of first alignment mark units formed on the electrode terminals; and
a plurality of second alignment mark units formed on the first terminals of the signal transfer units.

3. The display device of claim 2, wherein each first alignment mark unit is integrally formed with one of the electrode terminals.

4. The display device of claim 3, wherein each electrode terminal having an integrally formed first alignment mark includes a pair of sidewalls and wherein each first alignment mark unit is integrally formed with the respective electrode terminal by extending a predetermined region from both sidewalls of the electrode terminal.

5. The display device of claim 2, wherein each second alignment mark unit comprises a recognition unit in which an opening is formed to determine a position of a corresponding first alignment mark unit when the second alignment mark units overlap on the first alignment mark units.

6. The display device of claim 5, wherein the width of the opening is greater than the width of the corresponding first alignment mark unit such that the corresponding first alignment mark unit is recognizable through the opening.

7. The display device of claim 5, wherein with respect to each signal transfer unit, the first terminals are aligned in a row extending across a width of the signal transfer unit and wherein each signal transfer unit includes at least two second alignment mark units adjacent to the row of first terminals.

8. The display device of claim 2, wherein each second alignment mark unit comprises an opening formed in the signal transfer unit to recognize a corresponding first alignment mark unit when disposed on the corresponding first alignment mark unit.

9. The display device of claim 2, wherein each first alignment mark unit is integrally formed with an electrode terminal by extending a predetermined region from the electrode terminal, wherein with respect to each signal transfer unit, the first terminals are aligned in a row extending across a width of the signal transfer unit and wherein each signal transfer unit includes at least two second alignment mark units adjacent to the row of first terminals.

10. A display device comprising:
a panel comprising a plurality of groups of electrode terminals;
a plurality of signal transfer units, each signal transfer unit comprising a plurality of first terminals that connect with one of the plurality of groups of electrode terminals of the panel; and
wherein each group of electrode terminals includes at least two first alignment mark units formed on the panel, each first alignment mark unit being formed between one of the electrode terminals and an edge of the panel; and
wherein, with respect to each signal transfer unit, the first terminals are aligned in a row extending across a width of the signal transfer unit,
wherein each signal transfer unit includes at least two second alignment mark units adjacent to the row of first terminals, and
wherein the first alignment mark units and the second alignment mark units align positions of the first terminals of the signal transfer units with respect to the electrode terminals by overlapping each other in a region in which the electrode terminals and the terminals of the signal transfer unit are arranged.

11. The display device of claim 2, wherein the electrode terminals and the terminals of the at least one signal transfer unit are formed in rows, the first alignment mark units are formed on outermost electrode terminals, and the second alignment mark units are formed to correspond to the first alignment mark units.

12. The display device of claim 1, further comprising a plurality of driving circuit boards that transfer electrical signals to and from the panel, each of the driving circuit boards having connectors, and
wherein each signal transfer unit further comprises:
a plurality of driver integrated circuits (ICs);
second terminals that connect with one of the driving circuit boards;
a plurality of leads that are electrically connected with the driver ICs, and that are connected to the electrode terminals of the panel and the connectors of the driving circuit board through the first and the second terminals, respectively; and
a plurality of films having flexibility and that cover the leads and do not cover the first terminals and the second terminals.

13. The display device of claim 2, wherein the second alignment mark units are formed of a white conductive material to prevent reflection of light.

14. The display device of claim 13, wherein the second alignment mark units are formed of Ag, Pt, Au, or alloys thereof.

15. An electrode terminal-signal transfer unit assembly comprising:
a group of spaced apart electrode terminals;
a signal transfer unit having a plurality of signal transfer unit terminals;
first alignment mark units formed on at least two of the electrode terminals; and
second alignment mark units formed on the signal transfer unit,
wherein the group of spaced apart electrode terminals and the signal transfer unit are moveable with respect to each other from a separated or misaligned position to an aligned position,
wherein the signal transfer unit terminals are spaced apart such that each electrode terminal aligns with and contacts one of the signal transfer unit terminals when the group of spaced apart electrode terminals and the signal transfer unit are in the aligned position; and
wherein the second alignment mark units overlap the first alignment mark units when the group of spaced apart electrode terminals and the signal transfer unit are in the aligned position.

16. The electrode terminal-signal transfer unit assembly of claim 15, wherein each first alignment mark unit is integrally formed with one of the electrode terminals by extending a predetermined region from at least one sidewall of the electrode terminal and wherein each second alignment mark unit defines an opening through which the first alignment mark unit is detected when the group of spaced apart electrode terminals and the signal transfer unit are in the aligned position.

17. The electrode terminal-signal transfer unit assembly of claim 15, wherein for each first alignment mark unit and corresponding second alignment mark unit, the width of the opening holes is greater than the width of the first alignment mark units such that the first alignment mark units are recognizable through the opening holes.

18. The electrode terminal-signal transfer unit assembly of claim 15, wherein the group of spaced apart electrode terminals are in a row, wherein the group of spaced apart electrode terminals comprises opposing outermost electrode terminals and inner electrode terminals between the opposing outermost electrode terminals, wherein the first alignment mark units are on the outermost electrode terminals, wherein the signal transfer unit terminals are in a row aligning with the electrode terminals and wherein second alignment marks are formed adjacent to the row of signal transfer unit terminals.

19. A method of manufacturing a display device comprising:
preparing a substrate on which a plurality of grouped electrode terminals are patterned;
aligning a plurality of terminals of a plurality of signal transfer units on the substrate in order to electrically connect the terminals to the substrate;
disposing a plurality of second alignment mark units, which are formed on the signal transfer units, on a plurality of first alignment mark units, which are formed on electrode terminals, thereby determining positions of the first alignment mark units in a region in which the electrode terminals and the terminals of the signal transfer units are arranged; and
electrically connecting the electrode terminals and the terminals of the plurality of signal transfer units by thermal bonding.

20. The method of claim 19, wherein the determining positions of the first alignment mark units comprises overlapping the second alignment mark units comprising a plurality of opening holes formed in the signal transfer units with the first alignment mark units formed on the electrode terminals and thereby determining positions of the first alignment mark units through the opening holes.

21. The method of claim 20, wherein the width of the opening holes is formed to be greater than the width of the first alignment mark units.

22. A method of joining a group of electrode terminals to a signal transfer unit having a plurality of signal transfer unit terminals, wherein each of the electrode terminals aligns with and contacts one of the signal transfer unit terminals in an aligned position, the method comprising:
providing first alignment marks on at least two of the electrode terminals; and second alignment marks on the signal transfer unit wherein the second alignment mark units overlap the first alignment mark units when the group of spaced apart electrode terminals and the signal transfer unit are in the aligned position;
positioning the group of spaced apart electrode terminals and the signal transfer unit so that the second alignment mark units overlap the first alignment mark units, thereby placing the group of electrode terminals and the signal transfer unit in the aligned position; and
electrically connecting the group of electrode terminals and plurality of signal transfer unit terminals by thermal bonding.
